(19) United States
(12) Patent Application Publication
(10) Pub. No.: US 2026/0170237 A1
(43) Pub. Date: Jun. 18, 2026

(54) AI MODELS FOR VOICE-DICTATED TEXT EDITS IN MESSAGING APPS

(71) Applicant: East Coast IP, LLC, Raleigh, NC (US)

(72) Inventor: Russell Speight VanBlon, Raleigh, NC (US)

(21) Appl. No.: 18/986,550

(22) Filed: Dec. 18, 2024

(51) Int. Cl. G06F 40/166; G06F 3/04842; G06F 3/04845; G10L 15/26

(52) U.S. Cl. CPC G06F 40/166; G06F 3/04842; G06F 3/04845; G10L 15/26

(57) ABSTRACT

In one aspect, different portions of text from a speech recognition model may be accompanied by separate discrete edit selectors that are each selectable to quickly edit or delete the relevant portion of text prior to sending a text message, improving device operability and ease of use. The edit selectors may be presented adjacent to the respective text portions themselves in a text entry field of a text messaging app that is being used to send the text message. However, the edit selectors may be presented in other text-related implementations as well, including in word processing apps and social media posts. Additionally, in some specific instances, the size of the edit selectors may be inversely proportional to the actual level of confidence in the respective speech recognition result for the relevant portion of text.

The disclosure below relates to technically inventive, non-routine solutions that are necessarily rooted in computer technology and that produce concrete technical improvements. In particular, the disclosure below relates to artificial intelligence (AI) models for voice-dictated text edits in messaging apps.

### BACKGROUND

Currently, text messaging applications (“apps”) make it too difficult to edit voice-dictated text derived from imperfect speech recognition results. As recognized herein, further technological improvements can be realized to address the foregoing computer-related, technological problem.

### SUMMARY

Accordingly, in one aspect an apparatus includes a processor system and storage accessible to the processor system. The storage includes instructions executable by the processor system to receive first voice input and to execute speech recognition on the first voice input. Based on a first speech recognition result for the first voice input being above a threshold level of confidence, the instructions are executable to present first text corresponding to the first voice input in a text entry field of a text messaging application (app). The first text is presented unaccompanied by a discrete edit selector for the first text based on the first speech recognition result being above the threshold level of confidence. Additionally, based on the speech first recognition result for the first voice input being below the threshold level of confidence, the instructions are executable to present the first text in the text entry field along with a first discrete edit selector for the first text.

In various example implementations, the first discrete edit selector may be selectable to delete the first text from the text entry field and/or to edit the first text as presented in the text entry field.

In some example embodiments, the instructions may be executable to present, as part of a message draft and based on the first speech recognition result for the first voice input being above the threshold level of confidence, the first text corresponding to the first voice input in the text entry field unaccompanied by a discrete edit selector for the first text. Then for the same message draft, the instructions may also be executable to receive second voice input and to execute speech recognition on the second voice input. The instructions may then be executable to determine a second speech recognition result for the second voice input, with the second speech recognition result being below the threshold level of confidence. As part of the same message draft and based on the second speech recognition result being below the threshold level of confidence, the instructions may then be executable to present second text in the text entry field along with a second discrete edit selector for the second text. The second text may be presented in the text entry field concurrently with the first text.

Also in example embodiments, a presentation size for the first discrete edit selector may be selected by the processor system such that the selected presentation size is inversely proportional to an actual level of confidence in the first speech recognition result.

What’s more, in some cases an actual level of confidence in the first speech recognition result may be determined based on context associated with multiple words indicated in the first voice input. Additionally or alternatively, the actual level of confidence may be determined based on the first voice input indicating a different human voice than second voice input received before, with, and/or after the first voice input in a same microphone stream.

What’s more, if desired the instructions may also be executable to present the first text in the text entry field along with the first discrete edit selector, receive selection of the first discrete edit selector, and then use the selection of the first discrete edit selector to train a model being used to provide the first speech recognition result. In some specific instances, the model may include an artificial neural network.

Still further, in some example embodiments the apparatus may include a display on which the first text is presentable under control of the processor system.

In another aspect, a method includes receiving, at a device, first voice input. The method also includes executing, using the device, speech recognition on the first voice input. The method then includes, based on a first speech recognition result for the first voice input being above a threshold level of confidence, presenting first text corresponding to the first voice input in a text entry field of an application (app). The first text is presented unaccompanied by any discrete edit selector for the first text based on the first speech recognition result being above the threshold level of confidence. The method also includes, based on the first speech recognition result for the first voice input being below the threshold level of confidence, presenting the first text in the text entry field along with a first discrete edit selector for the first text.

In various non-limiting examples, the threshold level of confidence may vary based on a different voice being indicated in the first voice input than in second voice input received within a threshold period of time of receipt of the first voice input. Additionally or alternatively, the threshold level of confidence may vary based on a first context of the first voice input being different from a second context of second voice input received within a threshold period of time of receipt of the first voice input.

In some instances, the method may also include selecting a presentation size for the first discrete edit selector such that the selected presentation size is inversely proportional to an actual level of confidence in the first speech recognition result.

What’s more, if desired the method may include using selection of the first discrete edit selector to train a model being used to output the first speech recognition result.

In still another aspect, an apparatus includes at least one computer readable storage medium (CRSM) that is not a transitory signal. The at least one CRSM includes instructions executable by a processor system to receive first voice input and to execute speech recognition on the first voice input. Based on a first parameter of a first speech recognition result for the first voice input, the instructions are also executable to present first text corresponding to the first voice input in a text entry field of an application (app) along with a first discrete edit selector for the first text. The first discrete edit selector is presented in a first size based on a magnitude of the parameter.

In some implementations, the instructions may also be executable to receive second voice input in a same microphone stream as the first voice input and to execute speech recognition on the second voice input. Here, based on a second parameter of a second speech recognition result for the second voice input, the instructions may be further executable to present second text corresponding to the second voice input in the text entry field along with a second discrete edit selector for the second text. The second discrete edit selector may be presented in a second size based on a magnitude of the second parameter, and the second discrete edit selector may be different from the first discrete edit selector. Additionally, in one particular example, the first size may be different from the second size.

Still further, in some example embodiments the first parameter may be determined based on both a voice identification (ID) assigned to the first voice input and a context assigned to the first voice input.

Also if desired, the apparatus may include the processor system itself.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example computing system consistent with present principles;

FIGS. 2-5 illustrate example text message edits that can be performed through an example graphical user interface (GUI) of a text messaging app to seamlessly edit transcribed text consistent with present principles;

FIG. 6 shows example logic in flowchart format that may be executed by an apparatus consistent with present principles; and

FIG. 7 shows an example GUI that may be presented on a display for an end-user to configure one or more setting of a device or app to undertake present principles.

### DETAILED DESCRIPTION

This disclosure relates generally to aspects of consumer electronics (CE) devices and other types of client devices and servers. Thus, devices herein may include server and client components which may be connected over a network such that data may be exchanged between the client and server components. The client components may include one or more computing devices including mobile smart phones and other mobile devices, wearable devices, game consoles, extended reality (XR) headsets such as virtual reality (VR) headsets and augmented reality (AR) headsets, display devices such as televisions (e.g., smart TVs, Internet-enabled TVs), personal computers such as laptops, desktop, and tablet computers, and still other types of devices. These client devices may operate with a variety of operating environments. For example, a client device consistent with present principles may employ, as examples, Linux and Unix operating systems, operating systems from Microsoft, or operating systems from Apple or Google. These operating environments may be used to execute one or more browsing programs, such as a browser made by Microsoft, Apple, Google, or Mozilla. The operating environments may also be used to execute other Internet-networked dedicated mobile applications that can access websites hosted by the Internet servers over a network such as the Internet, a local intranet, or a virtual private network.

Servers and/or gateways may be used that may include one or more processors executing instructions that configure the servers to receive and transmit data over a network such as the Internet. Or a client and server can be connected over a local intranet or a virtual private network. A server or controller may be instantiated by a personal computer, mobile device, rack or blade server, etc.

As indicated above, information may be exchanged over a network between client devices and servers. To this end and for security, servers and/or clients can include firewalls, load balancers, temporary storages, and proxies, and other network infrastructure for reliability and security.

As used herein, instructions may refer to computer-implemented steps for processing information in the system. Instructions can be implemented in software, firmware or hardware, or combinations thereof and include any type of programmed steps undertaken by components of the system.

A processor may be any single- or multi-chip processor that can execute logic by means of various lines such as address lines, data lines, and control lines and registers and shift registers. Moreover, any logical blocks, modules, and circuits described below can be implemented or performed with a processor/processor system such as a central processing unit (CPU), a digital signal processor (DSP), a field programmable gate array (FPGA) or other programmable logic device, an application specific integrated circuit (ASIC), discrete gate or transistor logic, discrete hardware components, or any combination thereof designed to perform the functions described herein. A processor can be implemented by a controller or state machine or a combination of computing devices.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

The functions and methods described below, when implemented in software, can be written in an appropriate language such as but not limited to hypertext markup language (HTML)-5, Java®/Javascript, C# or C++, and can be stored on or transmitted from a computer-readable storage medium such as a hard disk drive (HDD) or solid state drive (SSD), random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

In an example, a processor system can access information over its input lines from data storage, such as a computer readable storage medium as referenced above, and/or the processor system can access information wirelessly from an Internet server by activating a wireless transceiver to send and receive data. Data typically is converted from analog signals to digital by circuitry between the antenna and the registers of the processor system when being received and from digital to analog when being transmitted. The processor system then processes the data through its shift registers to output calculated data on output lines, for presentation of the calculated data on the device, etc.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

The term “a” or “an” in reference to an entity refers to one or more of that entity. As such, the terms “a” or “an”, “one or more”, and “at least one” can be used interchangeably herein.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

Note that present principles may also employ machine learning models, including deep learning models. Machine learning models use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as one or more convolutional neural networks (CNNs) and/or one or more recurrent neural networks (RNNs) (such as a type of RNN known as a long short-term memory (LSTM) network). Support vector machines (SVM) and Bayesian networks also may be considered to be examples of machine learning models.

As understood herein, performing machine learning involves accessing and then training a model on training data to enable the model to process further data to make predictions. A neural network may include an input layer, an output layer, and multiple hidden layers in between that are configured and weighted to make inferences about an appropriate output.

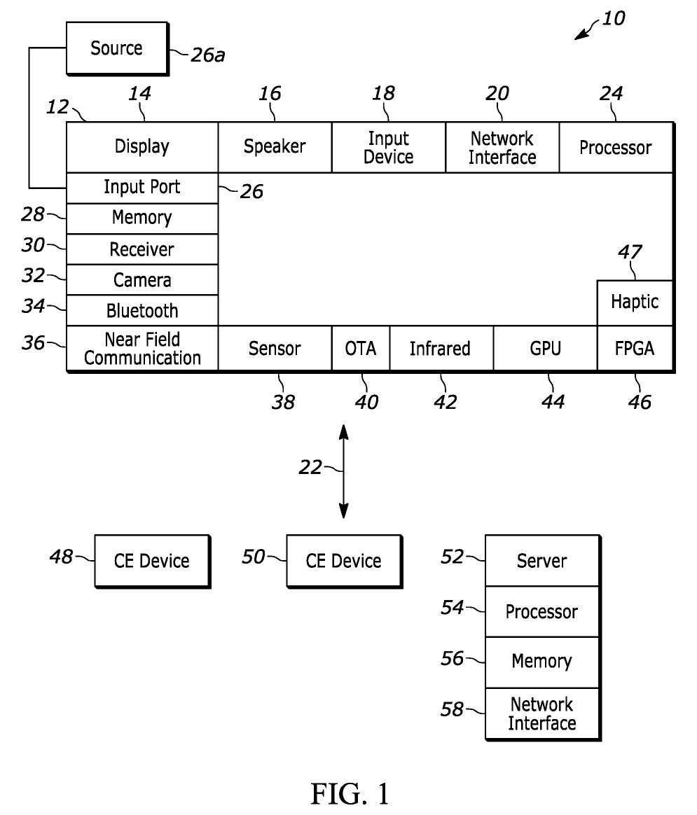

Referring now to FIG. 1, an example system 10 is shown, which may include one or more of the example devices mentioned above and described further below in accordance with present principles. The first of the example devices included in the system 10 is a consumer electronics (CE) device 12. The CE device 12 may be a computerized Internet enabled (“smart”) phone, a tablet computer, a laptop/notebook computer, a desktop computer, a head-mounted device (HMD) and/or headset such as smart glasses or AR or VR headset, another wearable computerized device, etc. Regardless, it is to be understood that the CE device 12 is configured to undertake present principles (e.g., communicate with other CE devices and servers to undertake present principles, execute the logic described herein, and perform other functions and/or operations described herein).

Accordingly, to undertake such principles the CE device 12 can be established by some, or all, of the components shown. For example, the CE device 12 can include one or more touch-enabled displays 14 that may be implemented by a high definition or ultra-high definition “4K” or higher flat screens. The touch-enabled display(s) 14 may include, for example, a capacitive or resistive touch sensing layer with a grid of electrodes for touch sensing consistent with present principles (e.g., to provide input to the GUIs discussed below).

The CE device 12 may also include an analog audio output port 15 to drive one or more external speakers or headphones, and may include one or more internal speakers 16 for outputting audio in accordance with present principles, and at least one additional input device 18 such as an audio receiver/microphone, e.g., for conversing telephonically or for entering audible commands to the CE device 12 to control the CE device 12. The example CE device 12 may also include one or more wired or wireless network interfaces 20 for communication over at least one network 22 such as the Internet, a WAN, a LAN, etc. under control of one or more processors of a processor system 24, such as a CPU or other processor mentioned above. Thus, the interface 20 may be, without limitation, a Wi-Fi transceiver and/or wireless telephony transceiver for communicating over a wireless cellular network (e.g., operated by Verizon, T-Mobile, or AT&T), both of which are examples of a wireless computer network interface.

It is to be understood that the processor system 24 may include one or more processors acting independently or in concert with each other to execute an algorithm (e.g., the algorithms referenced herein), whether those processors are in one device or more than one device. Thus, in some specific examples, the processor system may include a single processor, while in other examples the processor system may include more than one processor. The processor system 24 controls the CE device 12 to undertake present principles, including the other elements of the CE device 12 described herein such as controlling the display 14 to present images thereon and receiving input therefrom. Furthermore, also note the network interface 20 may be a wired or wireless modem or router or other suitable network interface.

In addition to the foregoing, the CE device 12 may also include one or more input and/or output ports 26 such as a high-definition multimedia interface (HDMI) port or a universal serial bus (USB) port to physically connect to another CE device, and/or a headphone port to connect headphones to the CE device 12 for presentation of audio from the CE device 12 to a user through the headphones. For example, the input port 26 may be connected wired or wirelessly to a cable or satellite source 26a of audio video content. Thus, the source 26a may be a separate or integrated set top box, or a satellite receiver. Or the source 26a may be a game console or disk player containing content.

The CE device 12 may further include one or more non-transitory computer memories/computer-readable storage media 28 such as disk-based or solid-state storage that are not transitory signals, in some cases embodied in the chassis/housing of the CE device 12 (e.g., as standalone devices) or as removable memory media or the below-described server(s). Also, in some embodiments, the CE device 12 can include a position or location receiver such as but not limited to a cell phone transceiver, global positioning system (GPS) transceiver, and/or altimeter 30. This transceiver may therefore be configured to receive geographic position information from a satellite or cellphone base station (and/or determine an altitude at which the CE device 12 is disposed) and then provide the information to the processor system 24. However, it is to be understood that another suitable position receiver other than a GPS receiver, cell phone transceiver, and/or altimeter may be used consistent with present principles to determine the location of the CE device 12. In some examples, the GPS transceiver 30 may be located on a streetlight or other infrastructure for which location is to be reported for purposes described in greater detail below.

Continuing the description of the CE device 12, in some embodiments the CE device 12 may include one or more cameras 32 that may be thermal imaging cameras, digital cameras such as webcams, infrared (IR) sensors, and/or other types of cameras or other optical sensors integrated into the CE device 12 and controllable by the processor system 24 to gather pictures/images and/or video consistent with present principles. Also included on the CE device 12 may be a Bluetooth^{®} transceiver 34 and/or other Near Field Communication (NFC) element 36 for communication with other devices using respective Bluetooth and/or NFC wireless technologies/communication standards. An example NFC element can be a radio frequency identification (RFID) element.

Further still, the CE device 12 may include one or more auxiliary sensors 38 that provide input to the processor system 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc.

Other sensor examples include a motion sensor such as an accelerometer, gyroscope, magnetometer, a speed and/or cadence sensor, an event-based sensor, a gesture sensor (e.g., for sensing gesture command), etc. In one specific example, the sensor 38 thus may be implemented as an inertial measurement unit (IMU) with motion sensors including individual accelerometers, gyroscopes, and magnetometers, and/or other components of that include a combination of accelerometers, gyroscopes, and magnetometers, to determine the location and orientation of the CE device 12 in three dimensions. A gyroscope consistent with present principles may sense and/or measure the orientation of the CE device 12 and provide related input to the processor system 24, an accelerometer consistent with present principles may sense acceleration and/or movement of the CE device 12 and provide related input to the processor system 24, and a magnetometer consistent with present principles may sense and/or measure directional movement of the CE device 12 and provide related input to the processor 122.

The CE device 12 may also include an over-the-air TV broadcast port 40 for receiving OTA TV broadcasts and providing the input to the processor system 24. In addition to the foregoing, it is noted that the CE device 12 may also include an IR transceiver 42 such as an IR data association (IRDA) device. A battery (not shown) may be provided for powering the CE device 12, as may a kinetic energy harvester that may turn kinetic energy into power to charge the battery and/or power the CE device 12. A graphics processing unit (GPU) 44 and field programmable gated array 46 also may be included.

One or more haptics/vibration generators 47 may also be provided for generating tactile signals/vibrations that can be sensed by a person holding or in contact with the device. The haptics generators 47 may thus vibrate all or part of the CE device 12 using an electric motor connected to an off-center and/or off-balanced weight via the motor’s rotatable shaft so that the shaft may rotate under control of the motor (which in turn may be controlled by a processor such as the processor system 24) to create vibration of various frequencies and/or amplitudes as well as force simulations in various directions.

In addition to the CE device 12, the system 10 may include one or more other CE devices/types, which may include some or all of the components mentioned above in relation to the CE device 12. In one example, a second CE device 48 may be established by an Internet of things (IoT) device, a smartphone, a laptop computer, etc. A third CE device 50 is also shown in FIG. 1 and may include similar components as the other CE devices. Thus, in one example, the CE device 50 may be configured as a head-mounted display (HMD) that may include a heads-up transparent or non-transparent display for respectively presenting extended reality (XR) content such as AR content, VR, content, and/or mixed reality (MR) content. The XR content itself might include, as an example, one or more of the GUIs described below, presented stereoscopically. The HMD may be configured as a glasses-type display, or as goggle-type and/or VR-type display vended by various computer hardware manufacturers such as Apple, Oculus, Meta, etc. Or the CE device 50 may be established by a smart streetlight consistent with present principles and, as such, the smart streetlight may include a network communication interface (e.g., Wi-Fi transceiver and/or cellular data transceiver) for communicating with other devices to implement present principles.

In the example shown, only three CE devices are shown, it being understood that fewer or more devices may be used. A device herein may implement some or all of the components shown for the CE device 12. Any of the components shown in the following figures may incorporate some or all of the components shown in the case of the CE device 12.

Now in reference to the afore-mentioned at least one server 52, it includes at least one server processor 54 and at least one tangible computer readable storage medium 56 such as disk-based or solid-state storage. The server 52 also includes at least one network interface 58 that, under control of the server processor 54, allows for communication with other illustrated devices over the network 22 (e.g., the Internet), and indeed may facilitate communication between the server 52 and any other servers/client devices as described herein. Note that the network interface 58 may be, e.g., a wired or wireless modem or router, Wi-Fi or Ethernet transceiver, or other appropriate interface such as, e.g., a wireless telephony transceiver.

Accordingly, in some embodiments the server 52 may be an Internet server or an entire server “farm” of multiple services. If desired, the server 52 may include/perform “cloud” functions such that the devices of the system 10 may access a “cloud” environment via the server 52 in certain example embodiments. Additionally or alternatively, the server 52 may be implemented by one or more computers in the same room as the other devices shown, or nearby.

The components shown in the following figures may include some or all components shown herein. Any user interfaces (UI) described herein may be consolidated and/or expanded, and UI elements may be mixed and matched between UIs. UIs may be presented at a client device like the CE device 12 under control of the client device itself and/or under control of the server 52 as remotely controlling the CE device 12 to present the UIs thereon. Also note that selectors and options on the UIs discussed below may be selected via cursor input, touch input to a touch-enabled display on which the GUI is presented, using voice input, and/or using other input methods.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

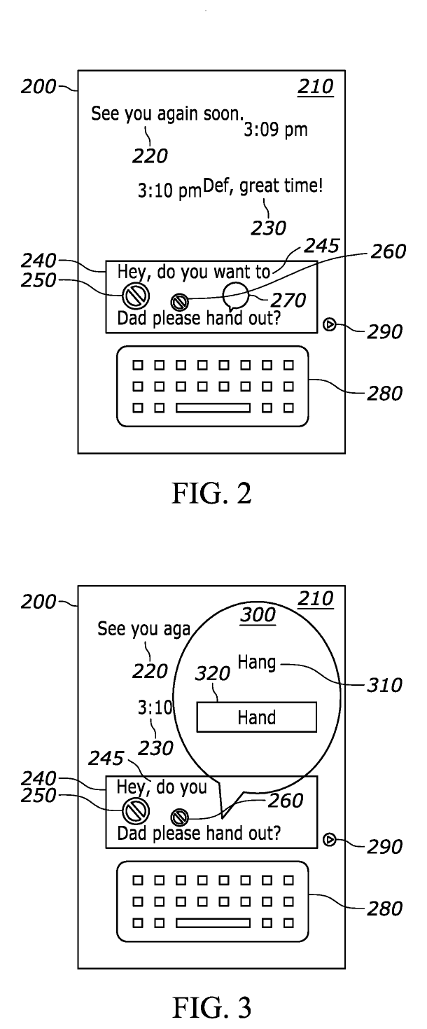

Now in reference to FIG. 2, an example graphical user interface (GUI) 200 is shown that may be presented as part of a text messaging application being executed at a client device (e.g., smartphone). The text messaging app may be a short message service (SMS) and/or multimedia messaging service (MMS) text messaging app, an Internet-based text messaging app such as a social media messenger or email app or encrypted messaging service app, or another type of app through which text-based messages can be exchanged between users. Or the app being executed may be another text-related app through which text transcriptions of voice input may be presented, including a word processor app, an Internet browser app, a slide presentation app, and even a social media app through which social media posts may be made and direct messages sent/received.

As shown in FIG. 2, the GUI 200 may include a message display area 210 showing previous messages 220, 230 with associated timestamps. The message 220 may be one sent to the user of the client device, while the message 230 may be one sent by the user to the other person on the text message chain (with it being further noted that present principles may apply to group messages for three or more people as well as to messages between only two messengers). Accordingly, the message display area 210 may present the message 220 “See you again soon” with a timestamp of “3:09 pm”. The area 210 may also present the message 230 “Def, great time!” below the message 220 with a timestamp of “3:10 pm”.

Below the message display area 210 on the GUI 200 may be a text entry field 240. In the present instance, the field 240 contains a message draft with text generated from voice input provided by the user through a microphone on the user’s client device. Here, the text entry field 240 presents the message 245, “Hey, do you want to Dad please hand out?” And as also shown in FIG. 2, above the different respective speech recognition results for the voice input, associated selectors 250, 260, 270 may be presented for deleting or editing the different discrete portions of the message 245 itself.

Note that the selector 250 may be presented as a circle with a diagonal line through it, indicating a delete edit action being associated with the selector 250. Thus, the selector 250 may be selectable to delete the discrete text “Dad” from the text entry field 240 in a single input action. The selector 260 may also include a circle with a diagonal line through it and may also be selectable to delete multi-character text in a single input action, but here the selector 260 is selectable to delete the discrete text “please” from the text entry field 240.

Also note the difference in presentation size between the selectors 250, 260. The first discrete edit selector 250 is presented larger than the second discrete edit selector 260 in the present example. This is based on the user’s client device selecting the presentation size of each selector 250, 260 such that the associated selector is presented in progressively larger form as the actual level of confidence in the respective speech recognition result for the associated voice input decreases. With this in mind, it may be appreciated that the actual level of confidence in the speech recognition result for “Dad” being an appropriate word given the context of the overall message draft (and/or other messages 220, 230) is lower than the actual level of confidence in the speech recognition result for “please”. However, as both actual levels of confidence are still below a threshold level of confidence (with the client device therefore determining that potentially neither one is a correct or intended message input), the selectors 250, 260 are presented for the respective speech recognition results. In contrast, further note that no discrete edit selectors are presented for the results for “Hey, do you want to” and “out?”

Describing the selector 270 in more detail, note that the selector 270 may be presented as a speech bubble as shown. The selector 270 may be selectable to edit the discrete text “hand” in the text entry field 240. Note that the size of the selector 270 may also be inversely proportional to the magnitude of the actual level of confidence in the associated speech recognition result for “hand”. The user may then select the selector 270 to cause a larger overlay 300 to be presented on the GUI 200 as shown in FIG. 3.

As shown in FIG. 3, the user may then provide a single input to select the selector 310 to command the client device to autonomously replace the associated word that is currently presented in the field 240 (“hand”) with the one shown on the face of the selector 310 (“hang”) itself. Or if the user wished to edit the current word character-by-character, the user may instead direct input to text input field 320 to cause a cursor to be presented for the user to then add or delete individual text characters from the relevant word as auto-populated into the field 320. The user may thus perform the text edits using the soft keyboard 280 as already presented on the GUI 200, with the keyboard 280 including various alphanumeric text keys, a backspace, a delete key, and/or a space bar, allowing for manual text input to edit the phrase “hand”. But also note that the user may perform character-by-character text edits in the field 320 using voice input as well.

Next, suppose the user selected the selector 310. As such, the client device may autonomously replace “hand” with “hand” in the message 245 and return the user to the GUI 200 (sans overlay 300) based on that single user input. Also suppose that at that point, the user also selects the selector 250, commanding the client device to delete the entire word “Dad” from the message 245 in a single input, thus rejecting that portion of the voice transcription. This is shown in FIG. 4, where the word “Dad” has been removed and the text “hand” has been replaced with “hang” according to selection of the selector 310. But note that the text “please” and associated discrete edit selector 260 are still presented as the user has not yet individually interacted with that word through the field 240. So if the user also does not want the word “please” to be included in the message 245, the user might then select the selector 260 to provide a command to the client device to delete the word “please” from the message 245 based on that single user input. The resulting (edited) message 245 as shown in FIG. 5 may then be sent to the recipient (other person on the message chain) responsive to selection of the send message selector 290.

It may now be appreciated that the selectors 250-270 may provide quick access to text editing functions to allow users to modify or correct text that has been generated through voice recognition, providing an intuitive and efficient user interface. Each selector 250-270 may be individually and separately selectable to seamlessly edit the associated individual, discrete text portions (one or plural words) on the fly without selecting or otherwise implicating the other portions of the text in the draft message 245, improving user ergonomics as well as enhancing the accuracy and usability of the device’s voice input feature itself. These techniques may also reduce opportunity for human error, also improving the overall performance of the system.

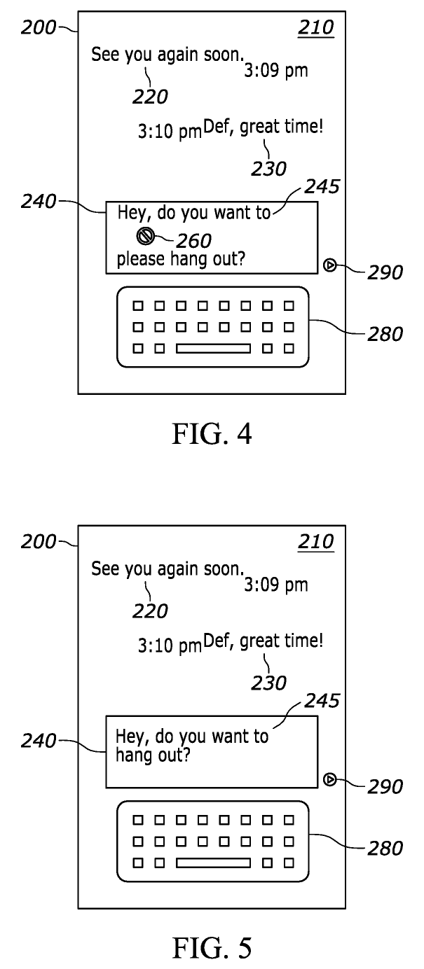

Now in reference to FIG. 6, this figure shows example logic that may be executed by an apparatus such as the CE device 12, a client device, and/or a coordinating server alone or in any appropriate combination consistent with present principles. Thus, in some examples the logic may be executed by a client device alone. In other examples, the logic may be executed by the remotely-located server alone. In still other examples, the logic may be executed by a client device and remotely-located server, where the client device performs some steps while the server performs other steps, and/or where the client device and server work together to perform a given step. Further note that while the logic of FIG. 6 is shown in flow chart format, other suitable logic may also be used (e.g., a state machine).

Beginning at block 600, the apparatus may receive a microphone stream of voice input. The microphone stream may be a constant, uninterrupted audio stream from the client device’s microphone and may indicate the user audibly speaking one or several words to compose a text message draft. From block 600 the logic may then proceed to block 610.

At block 610 the apparatus may process the sequence of voice inputs indicated in the microphone stream using one or more speech recognition algorithms to thus output one or more speech recognition results for the different parts of the voice input. In one particular example, an artificial intelligence (AI)-based speech-to-text model may be executed to output the speech recognition results along with respective levels of confidence (more generally, parameters) for the respective recognition results, as determined at block 620. The level of confidence (or other parameter) in the respective recognition result for a given word or words from the voice input may be determined based on the context associated with multiple words indicated in the voice input. Additionally or alternatively, the level of confidence in the respective recognition result may be determined based on the associated voice input for the relevant text indicating a different human voice than other parts of the voice input from the same microphone stream as received before, with, and/or after the associated voice input itself.

In terms of context, the AI speech-to-text model might execute one or more natural language processing (NLP) algorithms, such as one or more topic segmentation algorithms, lexical semantic algorithms, name-entity recognition algorithms, word-sense disambiguation algorithms, sentiment analysis algorithms, natural language understanding algorithms, and/or other types of NLP algorithms. Those algorithms may be executed to determine the primary or overall context of the message, and/or to determine the individual contexts for different word portions of the message. Words for which the assigned message context does not match a common message context assigned to other portions of the same message text may be tagged with metadata or otherwise flagged as having a low speech recognition result, which in turn may be used by the device to present a discrete edit selector for the associated text consistent with the disclosure above.

In terms of different voices, one or more voice identification (ID) algorithms may be executed on the different parts of the voice input received in the same single microphone stream to assign different voice IDs to different portions of that voice input. So if one portion of the voice input indicates a different human voice than other parts of the voice input as received before, with, and/or after the different voice input, the different voice input as disambiguated via voice ID may be tagged with metadata or otherwise flagged as having a low speech recognition result, which also may be used by the device to present a discrete edit selector for the associated text consistent with the disclosure above.

Thus, note that the actual level of confidence for (or other parameter related to) the accuracy of the respective speech recognition result for a select portion of the total voice input may vary based on both word context as well as whether another voice was detected. So in one particular example, if the user were trying to provide certain voice input simultaneously with a background voice from another person also being picked up by the microphone, the inconsistent words from the background person’s voice may be presented with discrete edit selectors for editing out of the draft message. This aspect may also be appreciated from the description of FIGS. 2-5, where “Dad please” may have been spoken by someone else while the user tried to provide voice input “Hey, do you want to hang out?”

From block 620 the logic may then proceed to decision diamond 630. At diamond 630 and as alluded to above, the apparatus may determine, for each separate voice recognition result from the voice input/microphone stream, whether the associated actual level of confidence in the respective recognition result is more than a threshold level of confidence. Based on a speech recognition result for the relevant voice input being above the threshold level of confidence (affirmative determination at diamond 630), the logic may proceed to block 640 where the apparatus may present the respective text corresponding to the relevant portion of the voice input in a text entry field of a text messaging application (app) being executed at the client device without the respective text being accompanied by any discrete edit selector for that text.

However, based on the speech recognition result for the voice input being below the threshold level of confidence (negative determination at diamond 630), the logic may instead proceed to block 650 where the apparatus may present the relevant text in the text entry field along with a respective discrete edit selector for that text (e.g., selector to delete or edit text). This may be done concurrently with presentation of other text in the same message draft that is unaccompanied by any discrete edit selector. And again note that each discrete edit selector itself may be presented in progressively smaller form (size) as an actual level of confidence in the respective speech recognition result for the respective voice input increases, and vice versa, such that the selected presentation size is inversely proportional to the magnitude of the actual level of confidence or other probability parameter for the respective speech recognition result.

What’s more, also note that in some examples, the threshold level of confidence for each discrete voice recognition result may itself vary based on a different voice and/or different context being indicated in the associated voice input than in other portions of the voice input received within a threshold period of time of the different voice/context input (in the same microphone stream). Thus, while the actual level of confidence in one recognition result may be impacted by a different voice being used, if that level of confidence still meets or is higher than an elevated threshold level of confidence for different voices (elevated compared to the threshold level used for the rest of the total voice input), the associated text may still be presented as a message draft unaccompanied by any discrete edit selector for that text.

This might occur when, for example, different people are both detected as speaking but, based on the context of each person’s speech, they are both intentionally dictating a combined message to the client device. As such, the associated text may be presented without discrete edit selectors if the actual recognition results are still higher than the elevated threshold based on the context of the voice inputs themselves.

Still in reference to FIG. 6, from block 650 the logic may proceed to block 660. At block 660 the device may receive selection of a presented discrete edit selector. In response, at block 670 the apparatus may execute the associated function(s), such as delete and text edit functions as described above.

The logic may then proceed to block 680 where the apparatus may use the selection of the relevant discrete edit selector to train the speech-to-text model or whatever other artificial neural network (ANN) was being used. This may be done to train the model to better-make disambiguations and inferences in the future.

Different machine learning techniques may therefore be used to train the model, such as but not limited to supervised learning and reinforcement learning. The model may thus be trained on respective data pairs of (a) text strings accompanied by context and voice ID metadata and (b) corresponding ground truth labels for whether one or more words of the associated text string were low-confidence results for which associated discrete edit selectors should be presented. Again note that one or more data pairs in the training dataset may be sourced from confirmed deleted or edit actions received at block 660.

It may now be appreciated that in executing the logic of FIG. 6, a device may present corresponding text from a transcription in a text messaging interface unaccompanied by any discrete edit selector when the device has a high level of confidence in the recognition result, allowing for a clean, uncluttered presentation of text for transcribed portions that are more likely to be accurate. But at the same time, if the confidence threshold is not met for certain portions of the transcribed text, the device may present those text portions along with respective discrete edit selectors that both serve as visual indicators for the user to easily identify those portions as well as serve as tools for seamlessly modifying potentially inaccurate transcription portions. And since the size of the discrete edit selectors may each be inversely proportional to the magnitude of the respective actual level of confidence in the respective speech recognition result, text portions with lower actual levels of confidence may have larger, more prominent edit selectors presented with them while those with higher (but still below-threshold) levels of confidence may have smaller selectors presented with them. The system may also use these user edits to train the underlying speech-to-text model or other ANN being used for the speech recognition. This continuous learning process may help improve the accuracy of future transcriptions, potentially reducing the need for edits over time.

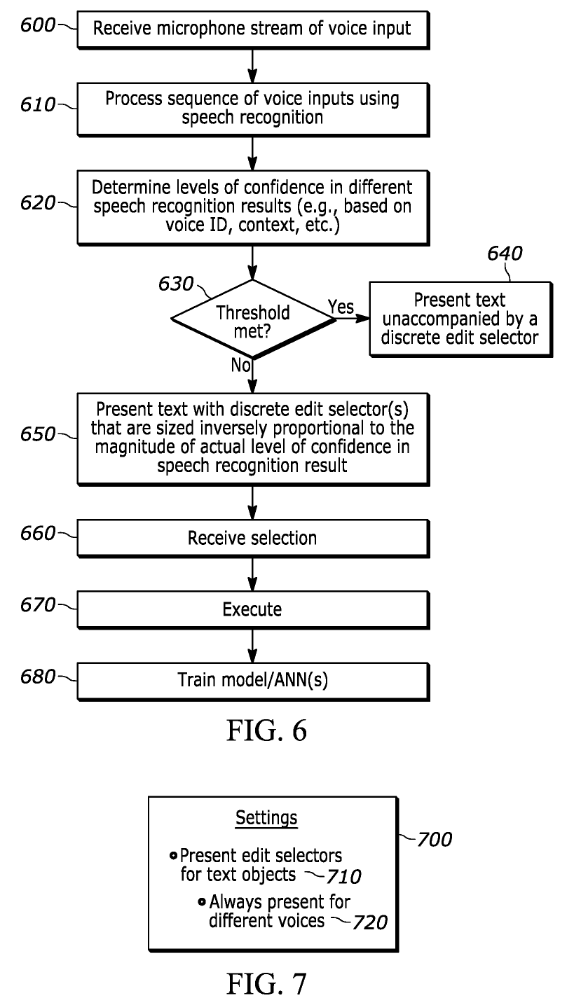

Turning to FIG. 7, this figure shows an example settings GUI 700 that may be presented on a display of a client device for an end-user to configure one or more settings of an apparatus or software application (“app”) to operate consistent with present principles. Each option discussed below may be selected by selecting the respective radio button shown adjacent to that option, whether through cursor input, touch input, or another type of input. The settings GUI 700 may be related to the app or device’s voice input features, allowing users to configure when and how text edit selectors are presented for transcribed text objects.

Accordingly, the GUI 700 may include an option 710 that is selectable a single time to set or configure the device to, for multiple future messaging instances, present edit selectors for text objects for which the respective confidence in the recognition result is below the relevant threshold. Thus, selection of the option 710 may set or configure the app or device to execute the functions described above in reference to FIGS. 2-6.

As also shown in FIG. 7, the GUI 700 may include a sub-option 720. The sub-option 720 may be selectable to set or configure the app or device to always present edit selectors for text objects associated with different detected voices than another voice used in a majority or plurality of the rest of the voice input from the same microphone stream.

Additional settings may also be included on the GUI 700, though not explicitly shown for simplicity. For example, the GUI 700 may include a setting for confidence threshold adjustment, where users can enter a particular level of confidence to use as the baseline threshold level at which discrete edit selectors are displayed. Additionally, the GUI 700 may include selector size preferences, enabling users to customize the size range for edit selectors based on confidence levels, as well as model training preferences to give the user control over how their edits are used to improve the speech recognition model. The settings GUI 700 might therefore include toggles, sliders, or dropdown menus to adjust these preferences.

In one particular aspect, an apparatus and method consistent with present principles may operate substantially as shown and described above but may also be claimed as including some but not all aspects in any intermediate claim approach.

Before concluding, it is to be understood that although a software application for undertaking present principles may be vended with a device, present principles apply in instances where such an application is downloaded from a server to a device over a network such as the Internet. Furthermore, present principles apply in instances where such an application is included on a computer readable storage medium that is vended and/or provided by itself, where the computer readable storage medium is not a transitory signal and/or a signal per se.

It may now be appreciated that present principles provide, among other technical improvements, improved computer-based user interfaces that increase the functionality and ease of use of the devices disclosed herein. The disclosed concepts are rooted in computer technology for computers to carry out their functions.

It is to be understood that whilst present principles have been described with reference to some example embodiments, these are not intended to be limiting, and that various alternative arrangements may be used to implement the subject matter claimed herein.

What is claimed is:

1. An apparatus, comprising:
a processor system; and
storage accessible to the processor system and comprising instructions executable by the processor system to:
receive first voice input;
execute speech recognition on the first voice input;
based on a first speech recognition result for the first voice input being above a threshold level of confidence, present first text corresponding to the first voice input in a text entry field of a text messaging application (app), the first text presented unaccompanied by a discrete edit selector for the first text based on the first speech recognition result being above the threshold level of confidence;
based on the speech first recognition result for the first voice input being below the threshold level of confidence, present the first text in the text entry field along with a first discrete edit selector for the first text.

2. The apparatus of claim 1, wherein the first discrete edit selector is selectable to delete the first text from the text entry field.

3. The apparatus of claim 1, wherein the first discrete edit selector is selectable to edit the first text as presented in the text entry field.

4. The apparatus of claim 1, wherein the instructions are executable to:
present, as part of a message draft and based on the first speech recognition result for the first voice input being above the threshold level of confidence, the first text corresponding to the first voice input in the text entry field unaccompanied by a discrete edit selector for the first text;
for the same message draft, receive second voice input;
execute speech recognition on the second voice input; and
determine a second speech recognition result for the second voice input, the second speech recognition result being below the threshold level of confidence; and
as part of the same message draft and based on the second speech recognition result being below the threshold level of confidence, present second text in the text entry field along with a second discrete edit selector for the second text, the second text being presented in the text entry field concurrently with the first text.

5. The apparatus of claim 1, wherein a presentation size for the first discrete edit selector is selected such that the selected presentation size is inversely proportional to an actual level of confidence in the first speech recognition result.

6. The apparatus of claim 1, wherein an actual level of confidence in the first speech recognition result is determined based on context associated with multiple words indicated in the first voice input.

7. The apparatus of claim 1, wherein an actual level of confidence in the first speech recognition result is determined based on the first voice input indicating a different human voice than second voice input received before, with, and/or after the first voice input in a same microphone stream.

8. The apparatus of claim 1, wherein the instructions are executable to:
present the first text in the text entry field along with the first discrete edit selector;
receive selection of the first discrete edit selector; and
use the selection of the first discrete edit selector to train a model being used to provide the first speech recognition result.

9. The apparatus of claim 8, wherein the model comprises an artificial neural network.

10. The apparatus of claim 1, comprising a display on which the first text is presentable under control of the processor system.

11. A method, comprising:
receiving, at a device, first voice input;
executing, using the device, speech recognition on the first voice input;
based on a first speech recognition result for the first voice input being above a threshold level of confidence, presenting first text corresponding to the first voice input in a text entry field of an application (app), the first text presented unaccompanied by a discrete edit selector for the first text based on the first speech recognition result being above the threshold level of confidence;
based on the first speech recognition result for the first voice input being below the threshold level of confidence, presenting on the first text in the text entry field along with a first discrete edit selector for the first text.

12. The method of claim 11, wherein the threshold level of confidence varies based on a different voice being indicated in the first voice input than in second voice input received within a threshold period of time of receipt of the first voice input.

13. The method of claim 11, wherein the threshold level of confidence varies based on a first context of the first voice input being different from a second context of second voice input received within a threshold period of time of receipt of the first voice input.

14. The method of claim 11, comprising:
selecting a presentation size for the first discrete edit selector such that the selected presentation size is inversely proportional to an actual level of confidence in the first speech recognition result.

15. The method of claim 11, comprising:
using selection of the first discrete edit selector to train a model being used to output the first speech recognition result.

16. An apparatus, comprising:
at least one computer readable storage medium (CRSM) that is not a transitory signal, the at least one CRSM comprising instructions executable by a processor system to:
receive first voice input;
execute speech recognition on the first voice input;
based on a first parameter of a first speech recognition result for the first voice input, present first text corresponding to the first voice input in a text entry field of an application (app) along with a first discrete edit selector for the first text, the first discrete edit selector presented in a first size based on a magnitude of the parameter.

17. The apparatus of claim 16, wherein the instructions are executable to:
receive second voice input in a same microphone stream as the first voice input;
execute speech recognition on the second voice input;
based on a second parameter of a second speech recognition result for the second voice input, present second text corresponding to the second voice input in the text entry field along with a second discrete edit selector for the second text, the second discrete edit selector presented in a second size based on a magnitude of the second parameter, the second discrete edit selector being different from the first discrete edit selector.

18. The apparatus of claim 17, wherein the first size is different from the second size.

19. The apparatus of claim 16, wherein the first parameter is determined based on both a voice identification (ID) assigned to the first voice input and a context assigned to the first voice input.

20. The apparatus of claim 16, comprising the processor system.
